(19) United States
(12) Patent Application Publication
(10) Pub. No.: US 2023/0383587 A1
(43) Pub. Date: Nov. 30, 2023

(54) VEHICULAR OPENING AND CLOSING BODY CONTROL DEVICE

(71) Applicant: AISIN CORPORATION, Kariya (JP)

(72) Inventors: Kenta IZUMI, Kariya-shi (JP); Kosei KURAMOCHI, Kariya-shi (JP)

(73) Assignee: AISIN CORPORATION, Kariya (JP)

(21) Appl. No.: 18/322,082

(22) Filed: May 23, 2023

(30) Foreign Application Priority Data
May 25, 2022 (JP) 2022-085343
Apr. 6, 2023 (JP) 2023-062189

(51) Int. Cl. E05F 15/63

(52) U.S. Cl. CPC E05F 15/63; E05Y 2900/531; E05Y 2400/36; E05Y 2400/415

(57) ABSTRACT

A vehicular opening and closing body control device includes an opening and closing control unit for causing first and second opening and closing bodies that are provided in an opening of a vehicle and perform opening and closing operations in directions opposite to each other, to perform the opening and closing operations, wherein the opening and closing control unit synchronizes end timings of the opening and closing operations of the first and second opening and closing bodies having different opening and closing operation distances when the first and second opening and closing bodies are interlocked to perform opening operations and closing operations.

### CROSS REFERENCE TO RELATED APPLICATIONS

This application is based on and claims priority under 35 U.S.C. § 119 to Japanese Patent Application No. 2022-085343, filed on May 25, 2022, Japanese Patent Application No. 2023-062189, filed on Apr. 6, 2023, the entire content of which is incorporated herein by reference.

### TECHNICAL FIELD

The present disclosure relates to a vehicular opening and closing body control device.

### BACKGROUND DISCUSSION

A conventional vehicular opening and closing body control device controls a pair of opening and closing bodies having a so-called double-opening configuration in which opening and closing operations are performed in directions opposite to each other. For example, an electrically-driven vehicle described in Japanese Patent Application Laid-Open No. 2021-6444 uses two sliding doors having a double-opening configuration to open and close a door opening provided on a lateral surface of a vehicle body. This configuration secures a large door opening to ensure smooth entry and exit of an occupant.

However, in a case where there is a difference in opening and closing operation distances between the two opening and closing bodies until reaching target positions when the two opening and closing bodies are interlocked to perform the opening and closing operations, a user may feel a dispersion in the interlocked opening and closing operations. This may deteriorate the texture.

A need thus exists for a vehicular opening and closing body control device which is not susceptible to the drawback mentioned above.

### SUMMARY

A vehicular opening and closing body control device includes an opening and closing control unit for causing first and second opening and closing bodies that are provided in an opening of a vehicle and perform opening and closing operations in directions opposite to each other, to perform the opening and closing operations, wherein the opening and closing control unit synchronizes end timings of the opening and closing operations of the first and second opening and closing bodies having different opening and closing operation distances when the first and second opening and closing bodies are interlocked to perform opening operations and closing operations.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a front view of a front door and a rear door provided in a door opening of a vehicle;

FIG. 2 is a front view of the front door and the rear door provided in the door opening of the vehicle;

FIG. 3 is a top view of a door device for performing opening and closing operations of the front door and the rear door of the vehicle;

FIG. 4 is a perspective view of the door device for performing opening and closing operations of the front door and the rear door of the vehicle;

FIG. 5 is a plan view of a joint link mechanism constituting a connection length changing mechanism;

FIG. 6 is a plan view of the joint link mechanism constituting the connection length changing mechanism;

FIG. 7 is an explanatory view illustrating an opening and closing operation trajectory of the front door and the rear door in the vicinity of a full-closed position;

FIG. 8 is a schematic configuration diagram of a door-side engagement part and a vehicle-body-side engagement part;

FIG. 9 is a control block diagram of the vehicular opening and closing body control device;

FIG. 10 is an explanatory view illustrating a difference in an opening and closing operation distance between a full-closed position and a full-open position set for the front door and the rear door, and a check position;

FIG. 11 is a diagram for explaining synchronous control of end timing executed at the time of interlocking control in a first embodiment;

FIG. 12 is a flowchart illustrating processing procedures of synchronous control of end timing executed at the time of interlocking control in the first embodiment;

FIG. 13 is a time chart illustrating a mode of synchronous control of end timing executed at the time of interlocking control in the first embodiment;

FIG. 14 is a diagram for explaining synchronous control of end timing executed at the time of interlocking control in a second embodiment;

FIG. 15 is a graph illustrating a mode of synchronous control of end timing executed at the time of interlocking control in the second embodiment;

FIG. 16 is a flowchart illustrating processing procedures of synchronous control of end timing executed at the time of interlocking control in the second embodiment;

FIG. 17 is a block diagram of a vehicular control device according to a third embodiment;

FIG. 18 is a diagram for explaining synchronous control of end timing executed at the time of interlocking control in the third embodiment;

FIG. 19 is a flowchart illustrating processing procedures of synchronous control of end timing executed at the time of interlocking control in the third embodiment;

FIG. 20 is a diagram for explaining synchronous control of end timing executed at the time of interlocking control in a fourth embodiment; and

FIG. 21 is a flowchart illustrating a processing procedure of synchronous control of end timing executed at the time of interlocking control in the fourth embodiment.

### DETAILED DESCRIPTION

### First Embodiment

Hereinafter, a first embodiment pertaining to a vehicular opening and closing body control device will be described in accordance with the drawings.

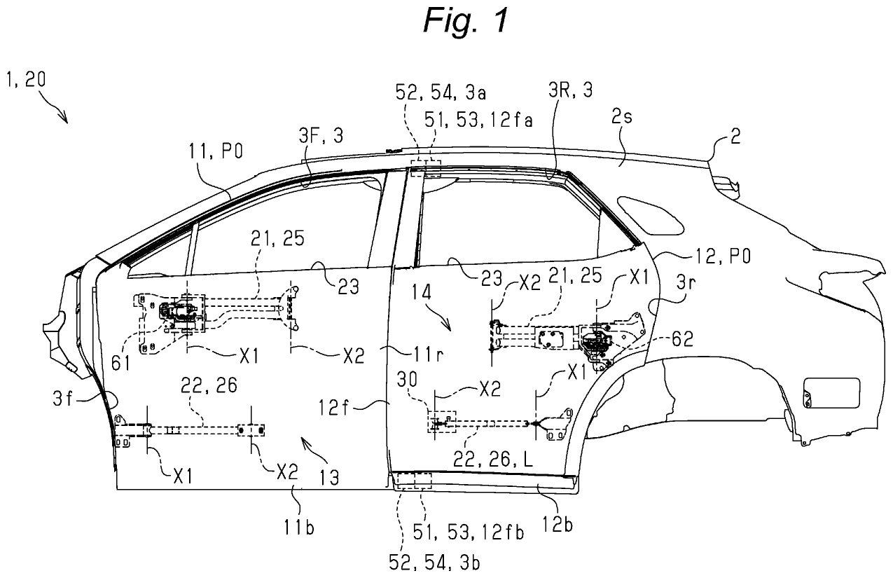

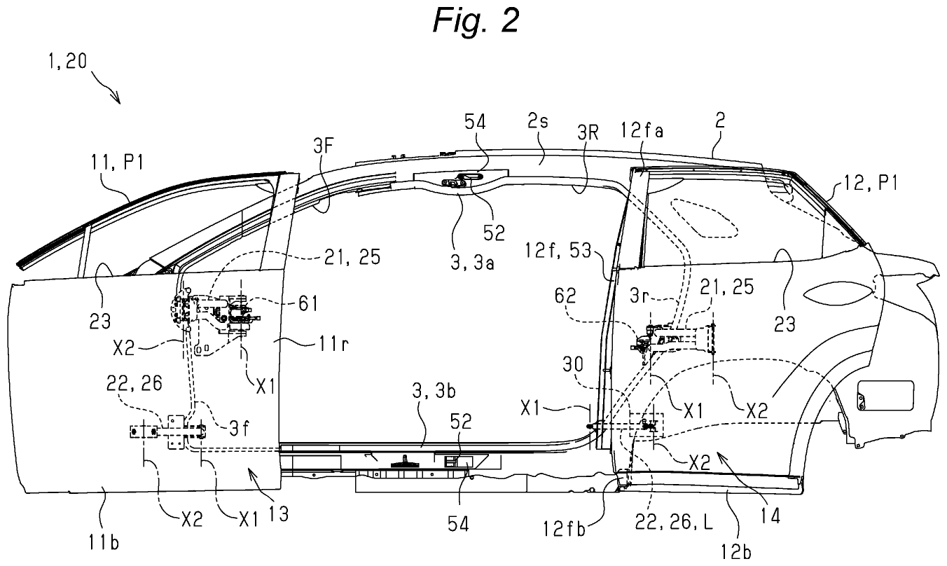

As illustrated in FIGS. 1 to 4, a vehicle 1 of the present embodiment has a door opening 3 provided on a lateral surface 2s of a vehicle body 2. The vehicle 1 of the present embodiment includes a front door 11 and a rear door 12 provided in the door opening 3.

Specifically, in the vehicle 1 of the present embodiment, the door opening 3 has a so-called pillar-less structure that does not have a pillar structure for dividing the door opening 3 into the front side and the rear side in an opening width direction along a vehicle front-rear direction (left and right direction in each drawing). The front door 11 and the rear door 12 are provided side by side in the opening width direction of the door opening 3 at positions corresponding to a front opening 3F and a rear opening 3R.

In addition, in the vehicle 1 of the present embodiment, the front door 11 and the rear door 12 are supported by the vehicle body 2 via independently-provided link mechanisms 13 and 14, respectively. Accordingly, the vehicular door device 20 which allows the front door 11 and the rear door 12 provided in the door opening 3 to independently perform an opening and closing operation in opposite directions based on the operations of the link mechanisms 13 and 14, is formed in the vehicle 1 of the present embodiment.

(Link Mechanism)

In the vehicular door device 20 of the present embodiment, the link mechanisms 13 and 14 each include first and second link arms 21 and 22 which are independent from each other. Furthermore, the first and second link arms 21 and 22 are rotatably connected to the vehicle body 2, and are rotatably connected to the corresponding front door 11 and rear door 12, respectively. Accordingly, in the vehicular door device 20 of the present embodiment, the link mechanisms 13 and 14 are configured as four-joint link mechanisms independent from each other.

Specifically, in the link mechanism 13 that supports the front door 11 in the front opening 3F, the first and second link arms 21 and 22 each have a first rotary connecting point X1 rotatably connected to the vehicle body 2 in the vicinity of a front edge 3f of the door opening 3. The first and second link arms 21 and 22 each also have a second rotary connecting point X2 rotatably connected to the front door 11 serving as a door of the vehicle 1. Furthermore, in the link mechanism 14 that supports the rear door 12 in the rear opening 3R, the first and second link arms 21 and 22 each have a first rotary connecting point X1 rotatably connected to the vehicle body 2 in the vicinity of a rear edge 3r of the door opening 3. The first and second link arms 21 and 22 each also have a second rotary connecting point X2 rotatably connected to the rear door 12 serving as a door of the vehicle 1.

In each of the link mechanisms 13 and 14, the corresponding first link arm 21 is disposed above the corresponding second link arm 22 which forms a counterpart thereof. Specifically, the first link arms 21 are disposed at a height below window portions 23 of the vehicle 1 formed respectively by the front door 11 and the rear door 12, that is, near a so-called belt line. The second link arms 22 are disposed at a height near lower ends 11b and 12b of the front door 11 and the rear door 12, respectively.

That is, in the vehicular door device 20 of the present embodiment, the first link arm 21 has the second rotary connecting point X2 at a position closer to the center of gravity of the front door 11 and the rear door 12 as compared with the second link arm 22. Accordingly, the vehicular door device 20 of the present embodiment is configured such that the first link arm 21 supports a larger door load as compared with the second link arm 22 in either of the link mechanisms 13 and 14.

Specifically, in the vehicular door device 20 of the present embodiment, each of the first link arms 21 positioned as a main link 25 is formed by connecting two parallel axial members. On the other hand, each of the second link arms 22 positioned as a sub-link 26 is formed using one axial member. Accordingly, the vehicular door device 20 of the present embodiment is configured to provide high support rigidity to the first link arms 21.

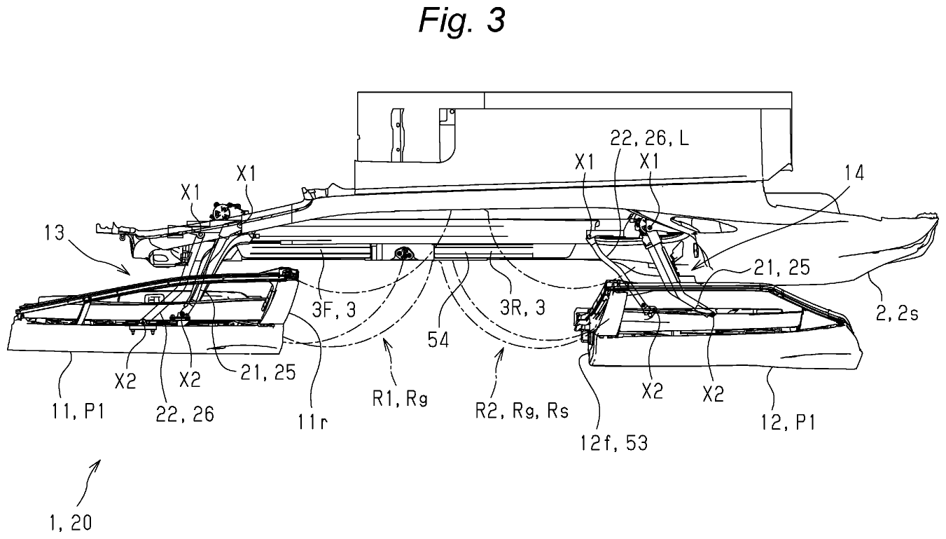

More specifically, as illustrated in FIG. 3, in the vehicular door device 20 of the present embodiment, the first and second link arms 21, 22 in the link mechanism 13 supporting the front door 11 each rotate clockwise in FIG. 3 around the first rotary connecting point X1 at the time of the opening operation. In the vehicular door device 20 of the present embodiment, at the time of the closing operation of the front door 11, the first and second link arms 21, 22 forming the link mechanism 13 thereof each rotate anti-clockwise in FIG. 3 around the first rotary connecting point X1. Accordingly, the vehicular door device 20 of the present embodiment is configured such that the front door 11 supported in the front opening 3F of the door opening 3 via the link mechanism 13 performs an opening operation toward the vehicle front side and performs a closing operation toward the vehicle rear side.

On the other hand, the first and second link arms 21, 22 in the link mechanism 14 supporting the rear door 12 each rotate anti-clockwise in FIG. 3 around the first rotary connecting point X1 at the time of the opening operation. Furthermore, in the vehicular door device 20 of the present embodiment, at the time of the closing operation of the rear door 12, the first and second link arms 21, 22 forming the link mechanism 14 thereof each rotate clockwise in FIG. 3 around the first rotary connecting point X1. Accordingly, the vehicular door device 20 of the present embodiment is configured such that the rear door 12 supported in the rear opening 3R of the door opening 3 via the link mechanism 13 performs an opening operation toward the vehicle rear side and performs a closing operation toward the vehicle front side.

That is, in the vehicular door device 20 of the present embodiment, an opening and closing operation trajectory R1 of the front door 11 is defined so as to draw an arc-shaped trajectory Rg based on the operation of the link mechanism 13. Similarly, an opening and closing operation trajectory R2 of the rear door 12 is defined so as to draw the arc-shaped trajectory Rg based on the operation of the link mechanism 14.

That is, in the vehicular door device 20 of the present embodiment, as the front door 11 and the rear door 12 supported by the link mechanisms 13 and 14 each approach a full-closed position P0, the first and second link arms 21 and 22 extend in the vehicle front-rear direction. Accordingly, the front door 11 and the rear door 12 each have a larger moving component heading in the vehicle width direction.

In addition, at intermediate opening and closing operation positions where the first and second link arms 21 and 22 respectively forming the link mechanisms 13 and 14 extend in the vehicle width direction, movement components of the front door 11 and the rear door 12 become larger in the vehicle front-rear direction. Accordingly, the vehicular door device 20 of the present embodiment is configured to be able to avoid interference with an obstacle and ensure a larger door opening amount at the time of an opening and closing operation of the front door 11 and the rear door 12 of the vehicle 1, by suppressing the displacement amount thereof in the vehicle width direction.

(Connection Length Changing Mechanism)

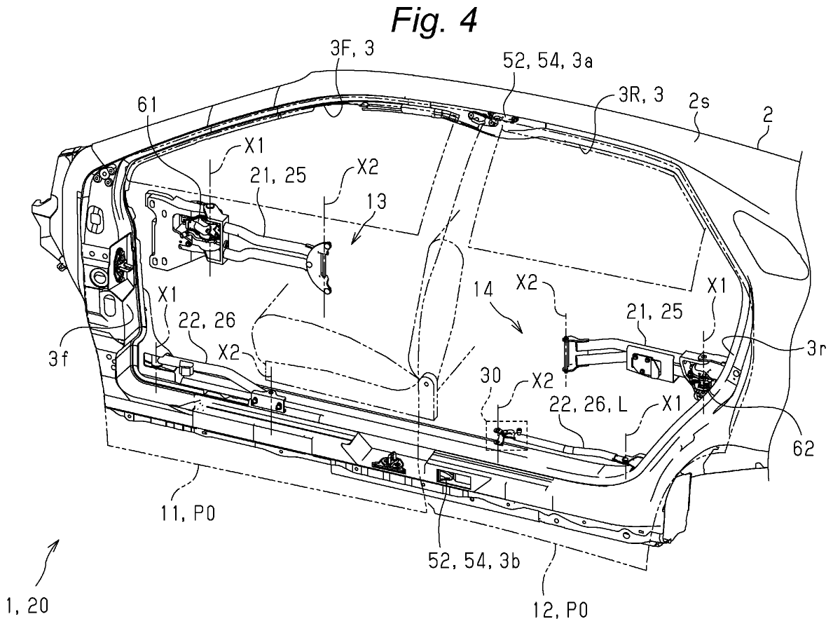

As illustrated in FIGS. 4-6, the vehicular door device 20 of the present embodiment includes a connection length changing mechanism 30 provided on the second link arm 22 in the link mechanism 14 that supports the rear door 12. In the vehicular door device 20 of the present embodiment, it is possible to change a connection length L between the first and second rotary connecting points X1 and X2 of the second link arm 22 forming the link mechanism 14 based on the operation of the connection length changing mechanism 30.

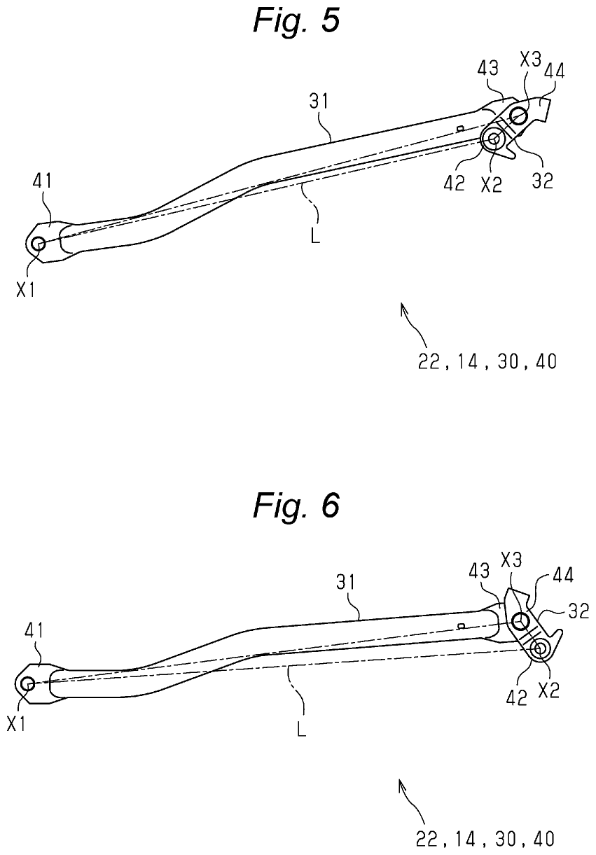

More specifically, as illustrated in FIGS. 5 and 6, in the vehicular door device 20 of the present embodiment, the second link arm 22 on the link mechanism 14 side is configured to include a vehicle-body-side link 31 and a door-side link 32. That is, the vehicle-body-side link 31 has a first rotary connecting point X1 with respect to the vehicle body 2. The door-side link 32 has a second rotary connecting point X2 with respect to the rear door 12 of the vehicle 1. Furthermore, the second link arm 22 on the link mechanism 14 side is configured to rotatably connect the vehicle-body-side link 31 and the door-side link 32. The vehicular door device 20 of the present embodiment is configured such that the joint link mechanism 40 thus formed functions as the connection length changing mechanism 30.

Specifically, as compared with the vehicle-body-side link 31, the door-side link 32 of the present embodiment has a configuration as a so-called mini arm having a short axial length. The vehicle-body-side link 31 has a vehicle-body-side connecting portion 41 with respect to the vehicle body 2 on one end side in the longitudinal direction thereof. Furthermore, the door-side link 32 has a door-side connecting portion 42 with respect to the rear door 12 on one end side in the longitudinal direction thereof. The vehicle-body-side link 31 and the door-side link 32 have, on the other end sides in the longitudinal direction, intermediate connecting portions 43 and 44 connected to each other.

That is, in the vehicular door device 20 of the present embodiment, the intermediate connecting portions 43 and 44 form an intermediate connecting point X3 of the joint link mechanism 40 provided in the second link arm 22 on the link mechanism 14 side supporting the rear door 12. In the second link arm 22, the vehicle-body-side link 31 and the door-side link 32 form a triangle with the intermediate connecting point X3 as a vertex. Accordingly, the vehicle-body-side link 31 and the door-side link 32 relatively rotate, whereby the length of a straight line connecting the first and second rotary connecting points X1 and X2 that serve as a bottom side of the triangle, that is, the connection length L thereof varies.

Note that, in the vehicular door device 20 of the present embodiment, a biasing member (not illustrated) applies a biasing force to the joint link mechanism 40 constituting the connection length changing mechanism 30 so as to relatively rotate the vehicle-body-side link 31 and the door-side link 32 around the intermediate connecting point X3. That is, the connection length changing mechanism 30 of the present embodiment is biased in such a direction that the connection length L of the rear door 12 is shortened by the second link arm 22 on the link mechanism 14 side provided with the connection length changing mechanism 30. Accordingly, the vehicular door device 20 of the present embodiment is configured such that, except a case described below in detail where the rear door 12 is in the vicinity of the full-closed position P0, the rear door 12 performs an opening and closing operation in a state where the connection length L is shortened by the second link arm 22.

(Opening and Closing Operation Trajectory in the Vicinity of a Full-Closed Position)

As illustrated in FIGS. 4-7, in the vehicular door device 20 of the present embodiment, the opening and closing operation trajectory R2 of the rear door 12 changes based on the operation of the connection length changing mechanism 30 provided in the second link arm 22 on the link mechanism 14 side that supports the rear door 12. Specifically, when the rear door 12 is placed in the vicinity of the full-closed position P0, the opening and closing operation trajectory R2 of the rear door 12 changes to a linear trajectory Rs. Accordingly, the vehicular door device 20 of the present embodiment is configured such that the front door 11 and the rear door 12 that independently perform an opening and closing operation do not interfere with each other based on the operations of the link mechanisms 13 and 14.

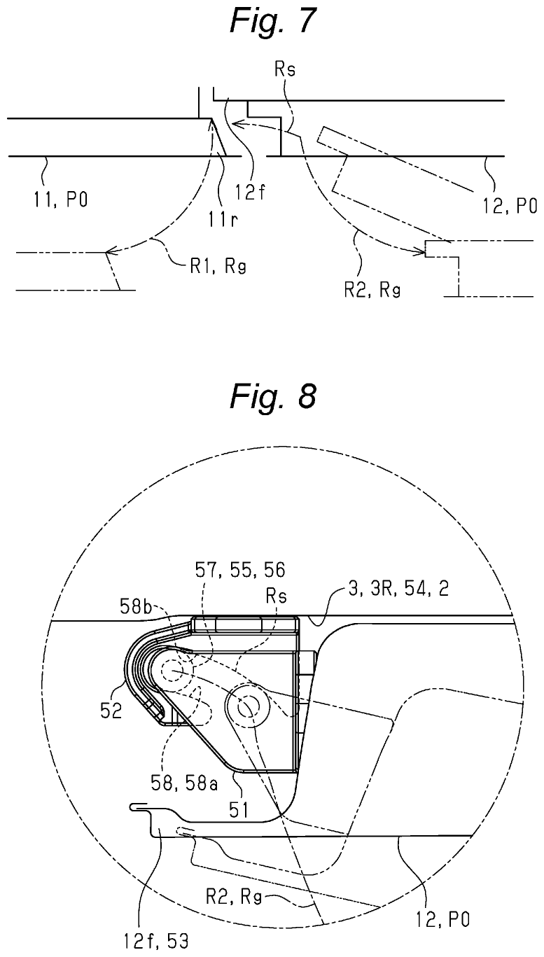

More specifically, as illustrated in FIG. 7, in the vehicle 1 of the present embodiment, when the rear door 12 is at the full-closed position P0, a front end 12f is disposed on a further inner side in the vehicle width direction as compared with a rear end 11r of the front door 11 also at the full-closed position P0. Therefore, even in the vicinity of the full-closed position P0, assuming that both the front door 11 and the rear door 12 perform an opening and closing operation on the arc-shaped trajectory Rg, there arises a problem such that the front end 12f of the front door 11 and the front end 12f of the rear door 12 interfere with each other.

In view of this point, in the vehicular door device 20 of the present embodiment, when the rear door 12 is placed in the vicinity of the full-closed position P0 as described above, the opening and closing operation trajectory R2 of the rear door 12 changes based on the operation of the connection length changing mechanism 30. Specifically, at the time of the full-closing operation of the rear door 12, the rear door 12 moves in a mode in which the front end 12f draws a linear trajectory Rs from the vehicle rear side toward the front side (from the right side to the left side in FIG. 7). At the time of the opening operation from the full-closed position P0, similarly, the rear door 12 moves in a mode in which the front end 12f draws a linear trajectory Rs from the vehicle front side toward the rear side (from the left side to the right side in FIG. 7). Accordingly, the vehicular door device 20 of the present embodiment allows the front door 11 and the rear door 12 to independently perform an opening and closing operation regardless of the opening and closing operation positions thereof.

(Door-Side Engagement Part and Vehicle-Body-Side Engagement Part)

More specifically, as illustrated in FIG. 8, the vehicular door device 20 of the present embodiment includes a door-side engagement part 51 provided at the front end 12f of the rear door 12. Furthermore, the vehicular door device 20 includes a vehicle-body-side engagement part 52 provided at a substantially center position in the opening width direction of the door opening 3 extending in the vehicle front-rear direction. That is, in the rear door 12 which performs a closing operation toward the vehicle front side, the front end 12f thereof serves as a closed-side end 53 of the rear door 12. Furthermore, in the rear opening 3R of the door opening 3 to which the rear door 12 is provided, the substantially center position in the opening width direction of the door opening 3 located at the front end portion thereof serves as a closed-side end 54. Accordingly, the vehicular door device 20 of the present embodiment is configured such that the door-side engagement part 51 and the vehicle-body-side engagement part 52 are engaged with each other when the rear door 12 is placed in the vicinity of the full-closed position P0.

Note that, as illustrated in FIG. 1, in the vehicle 1 of the present embodiment, the door-side engagement part 51 is provided at an upper end 12fa and a lower end 12fb on the front end 12f of the rear door 12. The vehicle-body-side engagement part 52 is provided at an upper edge 3a and a lower edge 3b at a substantially center position in the opening width direction of the door opening 3.

As shown in FIG. 8, the door-side engagement part 51 of the present embodiment includes, as a guide engagement part 55, an axial engagement part 56 extending in a vertical direction (a direction orthogonal to the paper surface in FIG. 8) of the vehicle 1. Note that, in the vehicular door device 20 of the present embodiment, the axial engagement part 56 serving as the guide engagement part 55 has a configuration as a roller 57 rotatably supported around a support shaft extending in the vertical direction. Furthermore, the vehicle-body-side engagement part 52 includes a guide groove 58 having a pair of lateral wall sections 58a and 58b facing each other in the vehicle width direction (the vertical direction in FIG. 8) and extending in an opening and closing operation direction of the rear door 12. Accordingly, the vehicular door device 20 of the present embodiment is configured such that the door-side engagement part 51 and the vehicle-body-side engagement part 52 are engaged with each other in a state where the roller 57 serving as the guide engagement part 55 and the axial engagement part 56 is placed inside the guide groove 58.

That is, the axial engagement part 56 of the door-side engagement part 51 is placed inside the guide groove 58 of the vehicle-body-side engagement part 52 in a state of being sandwiched between the pair of lateral wall sections 58a and 58b facing each other in the vehicle width direction, whereby the displacement of the rear door 12 in the vehicle width direction is restricted. Accordingly, the vehicular door device 20 of the present embodiment is capable of stably supporting the rear door 12 even in the vicinity of the full-closed position P0 where the first and second link arms 21 and 22 forming the link mechanism 14 are likely to be in a state of being arranged side by side.

Furthermore, the vehicular door device 20 of the present embodiment allows the opening and closing operation of the rear door 12 in a state where the door-side engagement part 51 and the vehicle-body-side engagement part 52 are engaged with each other based on the operation of the connection length changing mechanism 30 provided in the second link arm 22. Specifically, when the rear door 12 performs an opening and closing operation in a state where the door-side engagement part 51 and the vehicle-body-side engagement part 52 are engaged with each other, the roller 57 serving as the guide engagement part 55 is relatively displaced along the extending direction of the guide groove 58 together with the change of the connection length L based on the operation of the connection length changing mechanism 30. That is, in the vehicular door device 20 of the present embodiment, when the rear door 12 moves to the full-closed position P0, the door-side engagement part 51 is engaged with the vehicle-body-side engagement part 52, thereby guiding the opening and closing operation of the rear door 12 in a state where the roller 57 is placed inside the guide groove 58. Accordingly, the vehicular door device 20 of the present embodiment changes the opening and closing operation trajectory R2 of the rear door 12. That is, the arc-shaped trajectory Rg based on the operation of the link mechanism 14 that supports the rear door 12 changes to the linear trajectory Rs along the opening width direction of the door opening 3.

(Actuator)

As illustrated in FIGS. 1-4, the vehicular door device 20 of the present embodiment has a configuration as a so-called power door device that causes the front door 11 and the rear door 12 of the vehicle 1 to independently perform the opening and closing operations based on the driving forces of the actuators 61 and 62.

In the vehicular door device 20 of the present embodiment, the actuator 61 applies a driving force to the link mechanism 13 that supports the front door 11, thereby causing the front door 11 to perform the opening and closing operation. Similarly, the actuator 62 applies a driving force to the link mechanism 14 that supports the rear door 12, thereby causing the rear door 12 to perform the opening and closing operation.

More specifically, each of the actuators 61 and 62 rotationally drives the first link arm 21 positioned in the main link 25 of the corresponding link mechanism 13, 14. Specifically, each of the actuators 61 and 62 rotationally drives the first link arm 21 around the first rotary connecting point X1 with respect to the vehicle body 2 in a state of being fixed to the vehicle body 2. Accordingly, the vehicular door device 20 of the present embodiment is configured to allow the front door 11 and the rear door 12 respectively supported by the link mechanisms 13 and 14 to mutually perform the opening and closing operation based on the operations of the link mechanisms 13 and 14.

Note that, in the vehicle 1 of the present embodiment, at the time of the full-closing operation, the front door 11 and the rear door 12 respectively driven by the actuators 61 and 62 move to a position where a latch mechanism constituting a door lock device (not illustrated) becomes in a half-latched state. In other words, the front door 11 and the rear door 12 of the present embodiment move to a position where a so-called “door ajar state” is achieved by performing a full-closing operation based on the driving forces of the actuators 61 and 62. Furthermore, each of the door lock devices of the front door 11 and the rear door 12 is provided with a closer (not illustrated) that shifts the latch mechanism from the half-latched state to the fully-latched state using a motor as a driving source. Then, the front door 11 and the rear door 12 of the present embodiment respectively reach positions where the door opening 3 provided with the front door 11 and the rear door 12 is completely closed based on working of the closer called “retracting”, “closing”, or the like. Specifically, the front door 11 and the rear door 12 are configured to respectively reach positions where the front opening 3F and the rear opening 3R corresponding thereto are completely closed.

(Control Device)

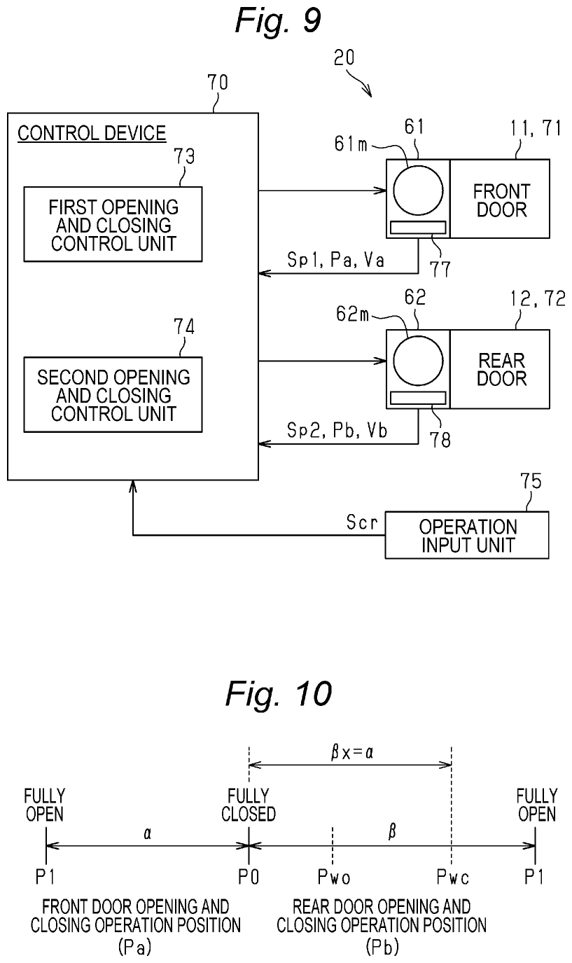

As shown in FIG. 9, in the vehicle 1 of the present embodiment, the working of the vehicular door device 20 configured as a power door device as described above is controlled by a control device 70. That is, the control device 70 controls the actuation of the actuators 61 and 62 respectively provided in the link mechanisms 13 and 14 constituting the vehicular door device 20 so as to cause the front door 11 and the rear door 12 respectively supported by the link mechanisms 13 and 14 to perform the opening and closing operations. Accordingly, the vehicle 1 of the present embodiment has an opening and closing body control device formed thereon that controls the opening and closing operation of the front door 11 and the rear door 12 as controlled objects.

More specifically, the actuators 61 and 62 of the present embodiment respectively use, as a driving source, motors 61m and 62m provided independently. Furthermore, the control device 70 controls the supply of drive power to each of the motors 61m and 62m. Thus, the control device 70 of the present embodiment is capable of independently controlling the actuation of the actuators 61 and 62, that is, the opening and closing operations of the front door 11 and the rear door 12 respectively driven by the actuators 61 and 62.

More specifically, the control device 70 of the present embodiment includes a first opening and closing control unit 73 that sets the front door 11 as a first opening and closing body 71 and controls the opening and closing operation thereof, and a second opening and closing control unit 74 that sets the rear door 12 as a second opening and closing body 72 and controls the opening and closing operation thereof. Furthermore, the control device 70 of the present embodiment receives, for example, an operation input signal Scr for an operation input unit 75 such as an operation switch provided in a vehicle interior or a portable device held by a user. The control device 70 of the present embodiment is configured such that, based on a working request indicated by the operation input signal Scr, the first opening and closing control unit 73 and the second opening and closing control unit 74 respectively control the opening and closing operations of the corresponding front door 11 and rear door 12.

Specifically, in the vehicle 1 of the present embodiment, the control device 70 receives, as the operation input signal Scr, a working request that requires the front door 11 and the rear door 12 to individually perform the opening and closing operations. The control device 70 also receives a working request that requires the front door 11 and the rear door 12 to perform the opening and closing operations in an interlocking manner. The control device 70 of the present embodiment is configured such that, based on these working requests, the first opening and closing control unit 73 and the second opening and closing control unit 74 execute an individual control on the front door 11 and rear door 12 and execute interlocking control on the front door 11 and rear door 12.

The control device 70 of the present embodiment also receives pulse signals Sp1 and Sp2 synchronized with the opening and closing operations of the front door 11 and the rear door 12. In the vehicle 1 of the present embodiment, the actuators 61 and 62 are respectively provided with pulse sensors 77 and 78 that output the pulse signals Sp1 and Sp2. Furthermore, the control device 70 of the present embodiment detects opening and closing operation positions Pa and Pb and opening and closing operation speeds Va and Vb of the front door 11 and the rear door 12 by counting the pulse signals Sp1 and Sp2. The control device 70 of the present embodiment is configured such that, based on the opening and closing operation positions Pa and Pb and the opening and closing operation speeds Va and Vb, the first opening and closing control unit 73 and the second opening and closing control unit 74 respectively control the opening and closing operations of the corresponding front door 11 and rear door 12.

Specifically, the control device 70 of the present embodiment starts controlling the working of the front door 11 and the rear door 12 as controlled objects without delay based on the working request indicated by the operation input signal Scr at a normal time during which no particular restriction is set. After starting the control, the control device 70 of the present embodiment causes the front door 11 and the rear door 12 as controlled objects to work at the opening and closing operation speeds Va and Vb corresponding to the opening and closing operation positions Pa and Pb. Note that, in the control device 70 of the present embodiment, the relation between the opening and closing operation positions Pa and Pb and the opening and closing operation speeds Va and Vb, that is, profiles of the opening and closing operation speeds Va and Vb corresponding to the opening and closing operation positions Pa and Pb are held in a speed control map (not illustrated). Furthermore, in the vehicle 1 of the present embodiment, the time required for the opening and closing operation of the front door 11 and the rear door 12 is shortened. Therefore, the control device 70 of the present embodiment is configured such that, in a case where no particular restriction is set, after the front door 11 and the rear door 12 start working, the front door 11 and the rear door 12 are caused to perform the opening and closing operations at a predetermined speed that causes the maximum utilization of driving performances of the actuators 61 and 62.

(Interlocking Control)

Next, a description will be given of the interlocking control of the front door 11 and the rear door 12 executed by the control device 70 of the present embodiment, specifically, the synchronous control of the end timing of the interlocked opening and closing operations of the front door 11 and the rear door 12 constituting the first and second opening and closing bodies 71 and 72.

Note that, in the vehicle 1 of the present embodiment, the “end timing of the opening and closing operation” in this case is a timing at which the interlocking control of the front door 11 and the rear door 12 through the actuation control of the actuators 61 and 62 executed by the control device 70 ends. That is, at the time of the full-closing operation of the front door 11 and the rear door 12, the timing at which the front door 11 and the rear door 12 each reach the position where the “closing” can be executed by the closer is the “end timing of the opening and closing operation”.

As illustrated in FIG. 10, in the vehicle 1 of the present embodiment, the front door 11 and the rear door 12 have different opening and closing operation distances α and β in the full-closing operation in which the door moves from the full-open position P1 to the full-closed position P0 and the full-opening operation in which the door moves from the full-closed position P0 to the full-open position P1. Specifically, the opening and closing operation distance β between the full-closed position P0 and the full-open position P1 set for the rear door 12 is longer than the opening and closing operation distance α between the full-closed position P0 and the full-open position P1 set for the front door 11 (α<β). Furthermore, in the vehicular door device 20 of the present embodiment, the actuators 61 and 62 that drive the front door 11 and the rear door 12 to open and close have substantially equal driving performances. Therefore, in case of causing the front door 11 and the rear door 12 to perform a full-closing operation and a full-opening operation individually, the rear door 12 has a longer time required from the start of working to the end thereof as compared with the front door 11.

In addition, the control device 70 of the present embodiment accepts, as the operation input signal Scr, a working request that requires both of the front door 11 and the rear door 12 to perform a full-closing operation from the full-open position P1 to the full-closed position P0. In addition, the control device 70 also accepts a working request that requires both of the front door 11 and the rear door 12 to perform a full-opening operation from the full-closed position P0 to the full-open position P1. The control device 70 of the present embodiment is configured such that the end timings of the opening and closing operations of the front door 11 and the rear door 12 are synchronized at the time of executing such interlocking control.

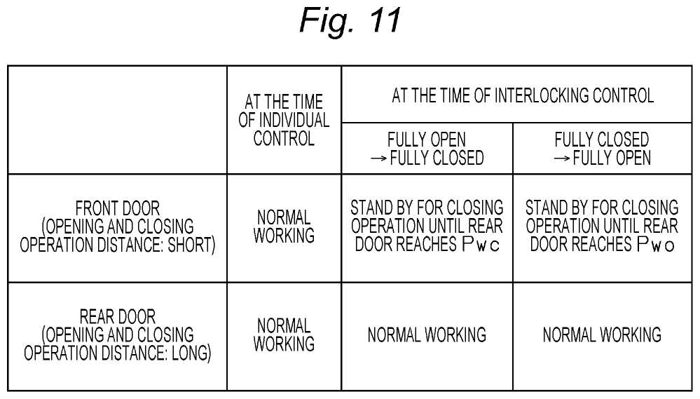

More specifically, as illustrated in FIG. 11, the control device 70 of the present embodiment causes the front door 11 and the rear door 12 as controlled objects to perform normal working at the time of executing an individual control during which the front door 11 and the rear door 12 are caused to perform the opening and closing operations individually. That is, upon the input of the operation input signal Scr, the working control based on the individual working requests is started without delay. On the other hand, at the time of executing the interlocking control for opening and closing the front door 11 and the rear door 12 in an interlocking manner, only the rear door 12 having a relatively longer opening and closing operation distance α between the full-closed position P0 and the full-open position P1 is caused to perform normal working. The front door 11 having a relatively short opening and closing operation distance β between the full-closed position P0 and the full-open position P1 is configured such that a working starting timing thereof is delayed.

Specifically, as illustrated in FIGS. 10 and 11, the control device 70 of the present embodiment causes the front door 11 to stand by at the full-open position P1 until the preceding rear door 12 reaches a predetermined check position Pwc at the time of executing the interlocking control in which a full-closing operation from the full-open position P1 to the full-closed position P0 is performed. In the control device 70 of the present embodiment, the check position Pwc is set at a position where the remaining opening and closing operation distance βx until the rear door 12 reaches the full-closed position P0 is equal to the opening and closing operation distance α of the front door 11 that stands by at the full-open position P1 (βx=α). Furthermore, in the present embodiment, the profiles of the opening and closing operation speeds Va and Vb corresponding to the opening and closing operation positions Pa and Pb are substantially equal for the front door 11 and the rear door 12 until the front door reaches the full-closed position P0 that is a target position, after the start of the working of the front door 11. Accordingly, the control device 70 of the present embodiment controls the working of the succeeding front door 11 with a working starting timing having been delayed and the preceding rear door 12 such that the front door 11 and the rear door 12 reach the full-closed position P0 that is a target position substantially simultaneously.

Similarly, the control device 70 of the present embodiment causes the front door 11 to stand by at the full-closed position P0 until the preceding rear door 12 reaches a predetermined check position Pwo at the time of executing the interlocking control in which a full-opening operation from the full-closed position P0 to the full-open position P1 is performed. In the control device 70 of the present embodiment, the check position Pwo is also set at a position where the remaining opening and closing operation distance βx until the rear door 12 reaches the full-open position P1 is equal to the opening and closing operation distance α of the front door 11 that stands by at the full-closed position P0. Furthermore, also in this case, the profiles of the opening and closing operation speeds Va and Vb corresponding to the opening and closing operation positions Pa and Pb are substantially equal for the front door 11 and the rear door 12 until the front door 11 reaches the full-open position P1 that is a target position, after the start of the working of the front door 11. Accordingly, the control device 70 of the present embodiment is configured to control the working of the front door 11 and the rear door 12 such that the succeeding front door 11 and the preceding rear door 12 reach the full-open position P1 substantially simultaneously.

(Operation)

Next, the operation of the present embodiment will be described.

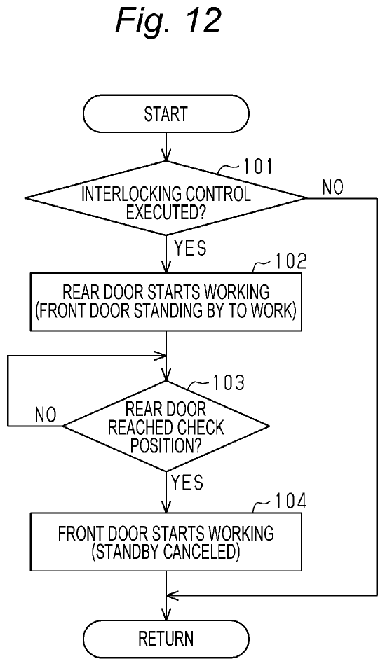

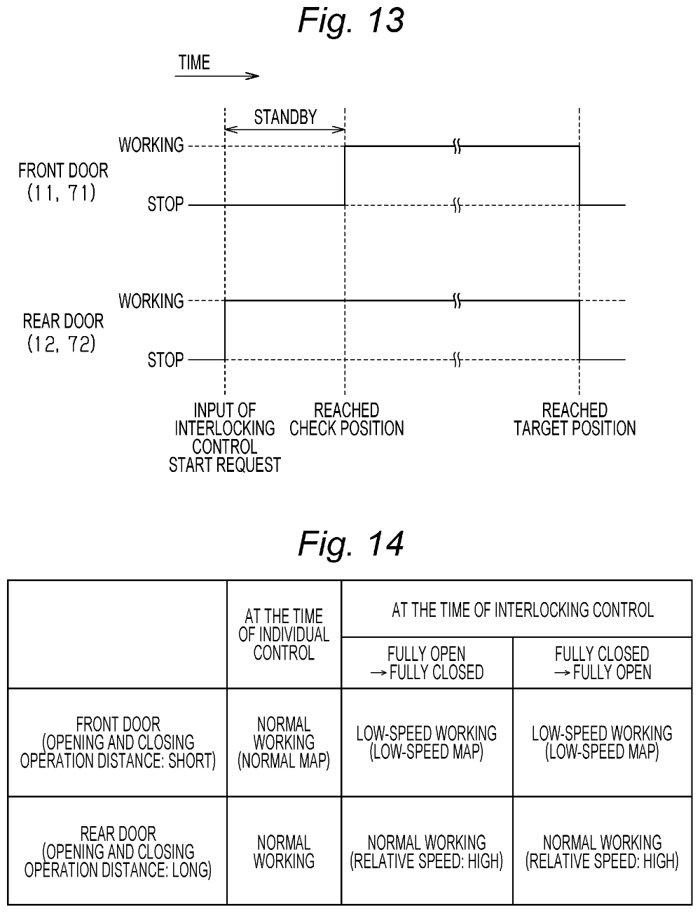

That is, as illustrated in FIGS. 12 and 13, at the time of executing interlocking control (step 101: YES), the control device 70 of the present embodiment firstly starts the working control only on the rear door 12 having a relatively long opening and closing operation distance β (step 102). The rear door 12 having a relatively short opening and closing operation distance α is caused to stand by at the working start position, without the working control being executed thereon.

Next, the control device 70 determines whether the preceding rear door 12 has reached a predetermined check position (step 103). Then, when the rear door 12 has reached the predetermined check position (step 103: YES), the control device 70 cancels the standby of the front door 11 and starts the working control on the front door 11 (step 104).

At this time, in the control device 70 of the present embodiment, the opening and closing operation distance α of the front door 11 that is succeeding and the remaining opening and closing operation distance βx of the rear door 12 that is preceding, are equal to each other, whereby the front door 11 and the rear door 12 reach the target positions substantially simultaneously. Accordingly, the opening and closing operations of the front door 11 and the rear door 12 are ended at the synchronized timing.

(Effects)

Next, the effects of the present embodiment will be described.

(1) The door opening 3 constituting an opening of the vehicle 1 is provided with a front door 11 and a rear door 12 as first and second opening and closing bodies 71 and 72 that perform the opening and closing operations in directions opposite to each other. The control device 70 serving as a vehicular opening and closing body control device includes a first opening and closing control unit 73 and a second opening and closing control unit 74 as an opening and closing control unit that causes the front door 11 and the rear door 12 to perform the opening and closing operations. When interlocking the front door 11 and the rear door 12 to perform an opening operation or a closing operation together, the control device 70 synchronizes the end timings of the opening and closing operations of the front door 11 and the rear door 12 having different opening and closing operation distances α and β.

According to the above configuration, a user hardly feels a dispersion in the interlocked opening and closing operations of the front door 11 and the rear door 12. Accordingly, it is possible to improve the texture.

(2) The front door 11 and the rear door 12 have different opening and closing operation distances α and β between the full-closed position P0 and the full-open position P1. Then, at the time of the interlocked full-closing operations and the interlocked full-opening operations, the control device 70 delays the start timing of the opening and closing operation of the front door 11 having a relatively short opening and closing operation distance α.

According to the above configuration, it is possible to synchronize the end timings of the interlocked opening and closing operations of the front door 11 and the rear door 12 with a simple configuration. In particular, at the time of the full-closing operation and the full-opening operation, the opening and closing operation distances α and β between the full-closed position P0 and the full-open position P1 set for the front door 11 and the rear door 12 have known values. Therefore, it is possible to accurately synchronize the end timings without performing special computational processing every time the interlocking control is executed.

### Second Embodiment

Hereinafter, a second embodiment pertaining to a vehicular opening and closing body control device will be described in accordance with the drawings. Note that, for convenience of description, components identical to those of the first embodiment are denoted by the same reference numerals to omit the description thereof.

The present embodiment is different from the first embodiment in terms of the mode of synchronous control in which the end timings of the opening and closing operations of the front door 11 and the rear door 12 are synchronized with each other, at the time of executing the interlocking control in which the front door 11 and the rear door 12 are caused to perform the opening and closing operations in an interlocking manner.

More specifically, as illustrated in FIG. 14, also in the present embodiment, such synchronous control of end timings is applied to the interlocked full-closing operations from the full-open position P1 and the interlocked full-opening operations from the full-closed position P0. Furthermore, in the present embodiment, at this time, the control device 70 causes only the front door 11 having a relatively low opening and closing operation distance α between the full-closed position P0 and the full-open position P1, as compared with the rear door 12, to work at a speed lower than that at the time of executing of the individual control (see FIG. 10). That is, control is executed such that the opening and closing operation speed Vb of the rear door 12 performing normal working becomes relatively faster than the opening and closing operation speed Va of the front door 11 working at a low speed (Vb>Va). Accordingly, the front door 11 having a relatively short opening and closing operation distance α between the full-closed position P0 and the full-open position P1 and the rear door 12 having a relatively longer opening and closing operation distance β are configured to reach the full-closed position P0 or the full-open position P1 serving as the target positions substantially simultaneously.

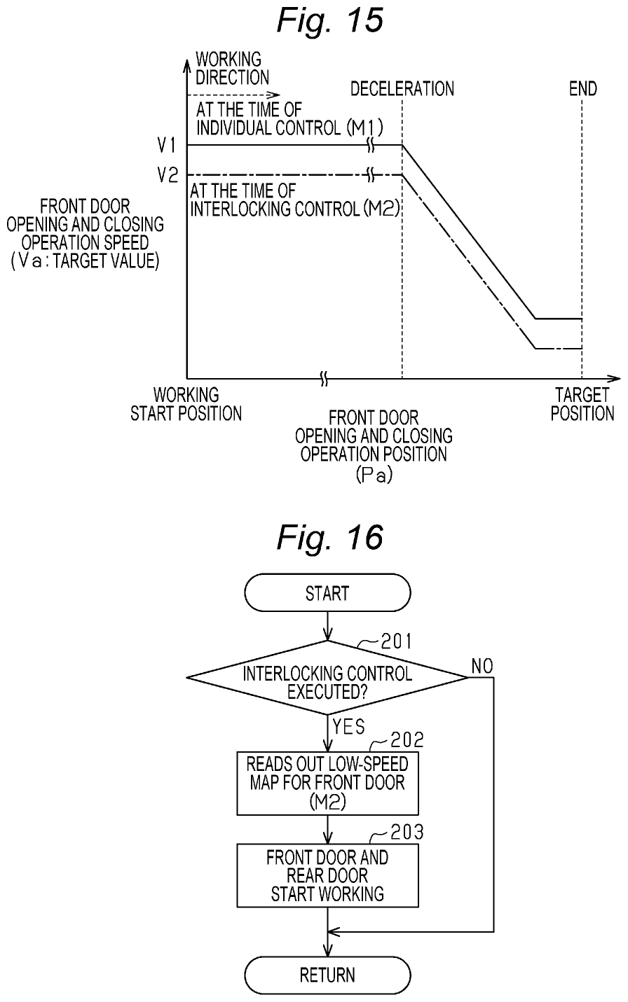

Specifically, as illustrated in FIG. 15, in the present embodiment, the control device 70 has a normal map M1 used at the time of the individual control and a low-speed map M2 used at the time of the interlocking control for the front door 11. In the low-speed map M2, a profile of the opening and closing operation speed Va that is lower than that of the normal map M1, that is, the opening and closing operation speed Va corresponding to the opening and closing operation position Pa is defined. Accordingly, in the present embodiment, the front door 11 is configured to start, at the time of the interlocking control, the working at the opening and closing operation speed V2 slower than the opening and closing operation speed V1 at the time of the individual control.

That is, as illustrated in FIG. 16, at the time of executing the interlocking control (step 201: YES), the control device 70 reads the low-speed map M2 from the storage area (not illustrated) for the front door 11 (step 202). Note that, as for the rear door 12, a control map (not illustrated) of the opening and closing operation speed Vb corresponding to the normal map M1 is read out as in the individual control. Then, the control device 70 simultaneously starts the working control of the front door 11 and the rear door 12 in an interlocking manner (step 203).

Note that, in the control map used for the working control of the front door 11 and the rear door 12, a deceleration profile for executing so-called slow stop control in which the opening and closing operation speeds Va and Vb are lowered in the vicinity of a target position is defined (see FIG. 15). In view of the above description, in the present embodiment, the low-speed map M2 is created such that the front door 11 having a relatively short opening and closing operation distance α and the rear door 12 having a relatively long opening and closing operation distance β reach the target positions substantially simultaneously.

As described above, the configuration of the present embodiment makes it possible to provide the same effects as provided by the first embodiment. Furthermore, at the time of executing the interlocking control, the front door 11 and the rear door 12 simultaneously start the working, whereby a feeling of dispersion is further less likely to occur in the interlocked opening and closing operations. Accordingly, it is possible to ensure a higher texture.

Further, the front door 11 having a short opening and closing operation distance α is controlled such that, by switching between the normal map M1 at the time of the individual control and the low-speed map M2 at the time of the interlocking control, the rear door 12 having a longer opening and closing operation distance β works relatively faster at the time of the interlocking control. The use of such a configuration makes it possible to inhibit a delay in the working time at the time of the individual control on the front door 11. As a result, a user's “feeling of being kept waiting” hardly occurs. Accordingly, it is possible to ensure a higher texture.

### Third Embodiment

Hereinafter, a third embodiment pertaining to a vehicular opening and closing body control device will be described in accordance with the drawings. Note that, for convenience of description, components identical to those of the first embodiment are denoted by the same reference numerals to omit the description thereof.

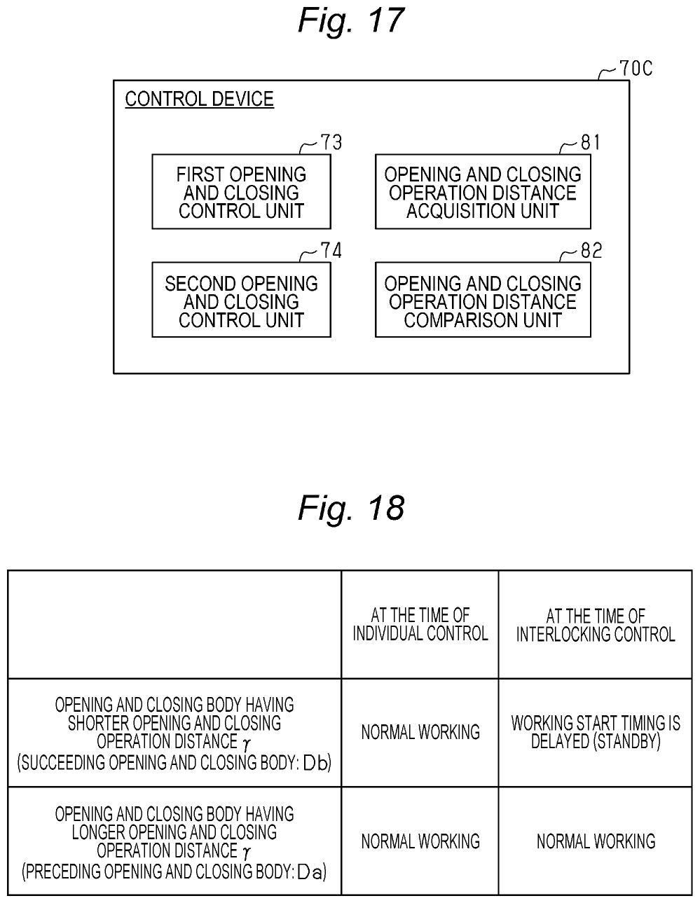

As illustrated in FIGS. 17 and 18, a control device 70C of the present embodiment includes an opening and closing operation distance acquisition unit 81 and an opening and closing operation distance comparison unit 82 in addition to a first opening and closing control unit 73 and a second opening and closing control unit 74 similar to those of the first embodiment. The opening and closing operation distance acquisition unit 81 acquires an opening and closing operation distance γ1 of the first opening and closing body 71 and an opening and closing operation distance γ2 of the second opening and closing body 72 by executing the interlocking control, respectively, at the time of executing the interlocking control of causing the first and second opening and closing bodies 71 and 72 to perform the closing operations or the opening operations together in an interlocking manner. Furthermore, the opening and closing operation distance comparison unit 82 performs a comparison between the opening and closing operation distance γ1 of the first opening and closing body 71 and the opening and closing operation distance γ2 of the second opening and closing body 72 which have been acquired. Furthermore, in the control device 70C of the present embodiment, among the first and second opening and closing bodies 71 and 72, the one with a longer opening and closing operation distance γ is positioned at the preceding opening and closing body Da, and the one with a shorter opening and closing operation distance γ is positioned at the succeeding opening and closing body Db. Then, the control device 70C of the present embodiment is configured such that the working start timing of the succeeding opening and closing body Db is delayed, thereby synchronizing the end timings of the interlocked opening and closing operations of the first and second opening and closing bodies 71 and 72.

That is, the control device 70C of the present embodiment also applies such synchronous control of end timings to the interlocking control except for the full-closing operation from the full-open position P1 and the full-opening operation from the full-closed position P0. For example, such synchronous control is also applied to a case where the first and second opening and closing bodies 71 and 72 perform a full-closing operation or a full-opening operation in an interlocking manner from a state where either one or both of the first and second opening and closing bodies 71 and 72 are in a half-open state, that is, stop between the full-closed position P0 and the full-open position P1. Accordingly, the control device 70C of the present embodiment can more effectively reduce a feeling of dispersion in the opening and closing operation.

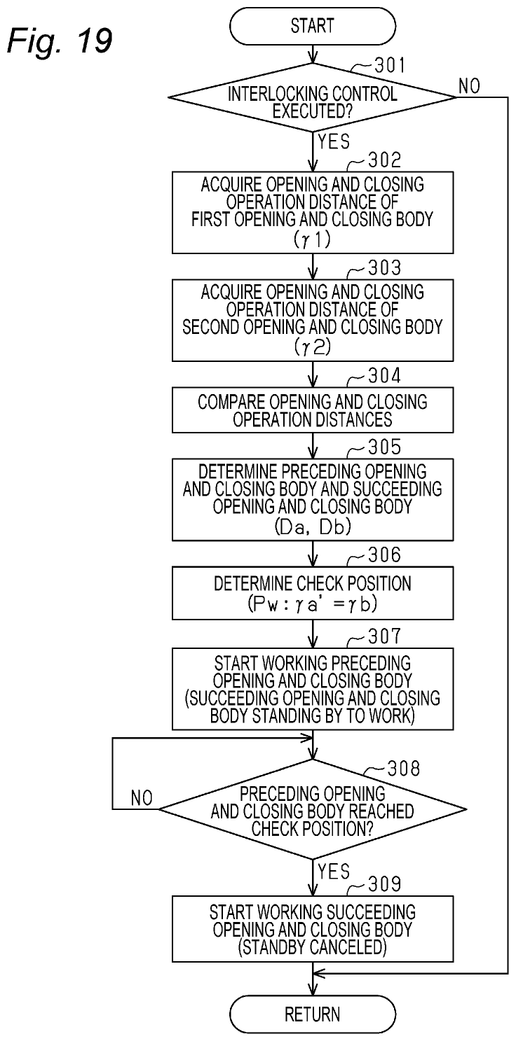

More specifically, as illustrated in FIG. 19, at the time of executing the interlocking control (step 301: YES), the control device 70C of the present embodiment acquires the opening and closing operation distance γ1 of the first opening and closing body 71 (step 302). The control device 70C also acquires the opening and closing operation distance γ2 of the second opening and closing body 72 (step 303). Then, the control device 70C compares the opening and closing operation distances γ1 and γ2 of the first and second opening and closing bodies 71 and 72 with each other (step 304). The control device 70C of the present embodiment determines the preceding opening and closing body Da and the succeeding opening and closing body Db for the first and second opening and closing bodies 71 and 72 based on the comparison between the opening and closing operation distances γ1 and γ2 in step 303 (step 305).

Next, the control device 70C of the present embodiment determines the check position Pw of the preceding opening and closing body Da based on the comparison between the opening and closing operation distances γ1 and γ2 in step 303 (step 306). In the control device 70C of the present embodiment, the check position Pw is set to a position where the remaining opening and closing operation distance γa′ until the preceding opening and closing body Da reaches the target position is equal to the opening and closing operation distance γb of the succeeding opening and closing body Db that stands by at the working start position (Pw:γa′=γb). Next, the control device of the present embodiment starts the working control of only the preceding opening and closing body Da having a relatively long opening and closing operation distance γ in a state where the succeeding opening and closing body Db having a relatively short opening and closing operation distance γ is caused to stand by at the working start position (step 307). Next, the control device determines whether the preceding opening and closing body Da has reached the predetermined check position Pw (step 308). Then, when the preceding opening and closing body Da has reached the check position Pw (step 308: YES), the control device 70C of the present embodiment cancels the standby of the succeeding opening and closing body Db and starts the working control on the succeeding opening and closing body Db (step 309).

That is, also in the control device 70C of the present embodiment, at this time, the opening and closing operation distance γb of the succeeding opening and closing body Db is equal to the remaining opening and closing operation distance γa′ of the preceding opening and closing body Da, whereby the preceding opening and closing body Da and the succeeding opening and closing body Db reach the target positions substantially simultaneously. Accordingly, the control device 70C of the present embodiment is configured such that the opening and closing operations of the first and second opening and closing bodies 71 and 72 end at a synchronized timing.

As described above, the configuration of the present embodiment makes it possible to provide the same effects as provided by the first embodiment. Furthermore, it is possible to synchronize the end timings of the interlocked opening and closing operations of the first and second opening and closing bodies 71 and 72 in a wider utilization situation. Accordingly, it is possible to reduce a feeling of dispersion in the opening and closing operation and ensure a high texture.

### Fourth Embodiment

Hereinafter, a fourth embodiment pertaining to a vehicular opening and closing body control device will be described in accordance with the drawings. Note that, for convenience of description, components identical to those of the respective embodiments mentioned above are denoted by the same reference numerals to omit the description thereof.

The present embodiment is different from the third embodiment in terms of the mode of synchronous control in which the end timings of the opening and closing operations of the front door 11 and the rear door 12 are synchronized with each other, at the time of executing the interlocking control in which the front door 11 and the rear door 12 are caused to perform the opening and closing operations in an interlocking manner.

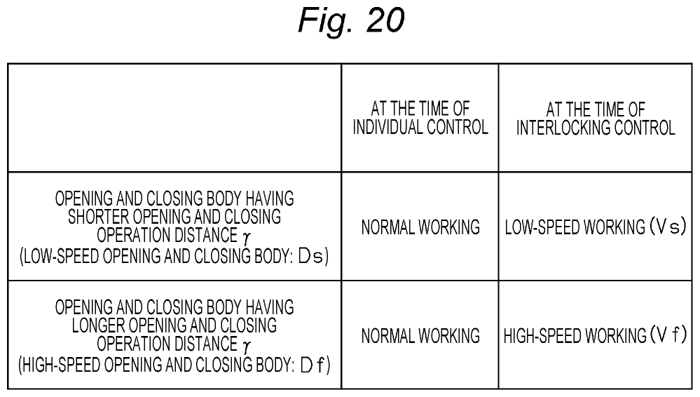

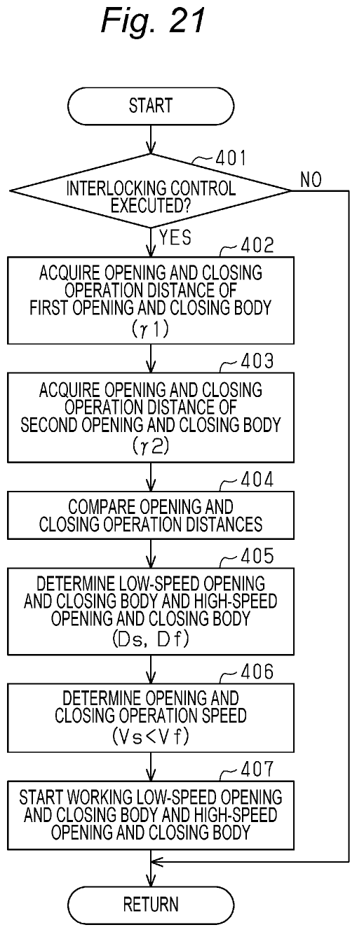

More specifically, as illustrated in FIGS. 20 and 21, also in the present embodiment, at the time of executing the interlocking control (step 401: YES), the control device 70C acquires the opening and closing operation distances γ1 and γ2 of the first and second opening and closing bodies 71 and 72 (step 402 and step 403). Then, the opening and closing operation distances γ1 and γ2 of the first and second opening and closing bodies 71 and 72 are compared (step 404).

Furthermore, in the present embodiment, the control device 70C defines, among the first and second opening and closing bodies 71 and 72, the one with a shorter opening and closing operation distance γ as a low-speed opening and closing body Ds, and the one with a longer opening and closing operation distance γ as a high-speed opening and closing body Df (step 405). Accordingly, control is executed such that, among the first and second opening and closing bodies 71 and 72, as compared with one side having a shorter opening and closing operation distance γ, another side having a longer opening and closing operation distance γ is working at a relatively high speed, thereby synchronizing the end timings of the opening and closing operations.

Specifically, in the present embodiment, the control device 70C determines the opening and closing operation speed Vs of the low-speed opening and closing body Ds and the opening and closing operation speed Vf of the high-speed opening and closing body Df based on a comparison between the opening and closing operation distances γ1 and γ2 in step 303 (step 406). That is, the opening and closing operation speed Vf faster than the opening and closing operation speed Vs of the low-speed opening and closing body Ds is set to the high-speed opening and closing body Df (Vs<Vf). Then, the control device 70C simultaneously starts the interlocked working control on the low-speed opening and closing body Ds and the high-speed opening and closing body Df at the opening and closing operation speeds Vs and Vf determined in step 406 (step 407).

Note that, in the present embodiment, the speed control profiles of the low-speed opening and closing body Ds and the high-speed opening and closing body Df, such as slow stop control, are defined on the basis of the opening and closing operation speeds Vs and Vf determined in step 406 described above. The control device 70C is configured to determine the opening and closing operation speeds Vs and Vf based on the speed control profiles such that the low-speed opening and closing body Ds and the high-speed opening and closing body Df having different opening and closing operation distances γ reach the target positions substantially simultaneously.

As described above, the configuration of the present embodiment can also provide the same effects as provided by the third embodiment. At the time of executing the interlocking control, the first and second opening and closing bodies 71 and 72 simultaneously start the working, which provides an advantage that a feeling of dispersion is further less likely to occur in the interlocked opening and closing operations.

(1) A vehicular opening and closing body control device includes an opening and closing control unit for causing first and second opening and closing bodies that are provided in an opening of a vehicle and perform opening and closing operations in directions opposite to each other, to perform the opening and closing operations, wherein the opening and closing control unit synchronizes end timings of the opening and closing operations of the first and second opening and closing bodies having different opening and closing operation distances when the first and second opening and closing bodies are interlocked to perform opening operations and closing operations.

According to the above configuration, a user hardly feels a dispersion in the interlocked opening and closing operations of the first and second opening and closing bodies. Accordingly, it is possible to improve the texture.

(2) A vehicular opening and closing body control device is configured such that, in the vehicular opening and closing body control device described in (1), the opening and closing control unit delays a start timing of the opening and closing operation of one side, among the first and second opening and closing bodies, having the opening and closing operation distance that is shorter.

According to the above configuration, it is possible to synchronize the end timings of the interlocked opening and closing operations of the first and second opening and closing bodies with a simple configuration.

(3) A vehicular opening and closing body control device is configured such that, in the vehicular opening and closing body control device described in (1), the opening and closing control unit executes control such that, as compared with one side, among the first and second opening and closing bodies, having the opening and closing operation distance that is shorter, another side having the opening and closing operation distance that is longer has a relatively faster opening and closing operation speed.

According to the above configuration, it is possible to accurately synchronize the end timings of the interlocked opening and closing operations of the first and second opening and closing bodies with a simple configuration. Furthermore, at the time of executing the interlocking control, it is possible to match start timings of the opening and closing operations. Accordingly, since a feeling of dispersion more hardly occurs in the interlocked opening and closing operations, it is possible to ensure a higher texture.

(4) A vehicular opening and closing body control device is configured such that, in the vehicular opening and closing body control device described in (1), the first and second opening and closing bodies have the opening and closing operation distances that differ from each other in a full-closing operation of moving from a full-open position to a full-closed position and a full-opening operation of moving from the full-closed position to the full-open position, and the opening and closing control unit synchronizes the end timings for at least either one of the interlocked full-closing operations and the interlocked full-opening operations.

According to the above configuration, at the time of the full-closing operation and the full-opening operation, the opening and closing operation distances between the full-closed position and the full-open position set for the first and second opening and closing bodies have known values. Therefore, it is possible to accurately synchronize the end timings without performing special computational processing every time the interlocking control is executed.

(5) A vehicular opening and closing body control device is configured such that, in the vehicular opening and closing body control device described in (2), the first and second opening and closing bodies have the opening and closing operation distances that differ from each other in a full-closing operation of moving from a full-open position to a full-closed position and a full-opening operation of moving from the full-closed position to the full-open position, and the opening and closing control unit synchronizes the end timings for at least either one of the interlocked full-closing operations and the interlocked full-opening operations.

According to the above configuration, at the time of the full-closing operation and the full-opening operation, the opening and closing operation distances between the full-closed position and the full-open position set for the first and second opening and closing bodies have known values. Therefore, it is possible to accurately synchronize the end timings without performing special computational processing every time the interlocking control is executed.

(6) A vehicular opening and closing body control device is configured such that, in the vehicular opening and closing body control device described in (3), the first and second opening and closing bodies have the opening and closing operation distances that differ from each other in a full-closing operation of moving from a full-open position to a full-closed position and a full-opening operation of moving from the full-closed position to the full-open position, and the opening and closing control unit synchronizes the end timings for at least either one of the interlocked full-closing operations and the interlocked full-opening operations.

According to the above configuration, at the time of the full-closing operation and the full-opening operation, the opening and closing operation distances between the full-closed position and the full-open position set for the first and second opening and closing bodies have known values. Therefore, it is possible to accurately synchronize the end timings without performing special computational processing every time the interlocking control is executed.

(7) A vehicular opening and closing body control device is configured such that, in the vehicular opening and closing body control device described in (1), the opening and closing control unit controls at least either one of the first and second opening and closing bodies at different opening and closing operation speeds between at a time of executing individual control when the first and second opening and closing bodies are caused to perform the opening and closing operations individually, and at a time of executing interlocking control when the first and second opening and closing bodies are caused to perform the opening and closing operations together.

According to the above configuration, setting different opening and closing operation speeds between at the time of executing the individual control and at the time of executing the interlocking control makes it possible to suppress a delay in the working time at the time of executing the individual control. As a result, a user's “feeling of being kept waiting” hardly occurs. Accordingly, it is possible to ensure a high texture.

(8) A vehicular opening and closing body control device is configured to include, in the vehicular opening and closing body control device described in (1), an opening and closing operation distance acquisition unit for acquiring the opening and closing operation distances of the first and second opening and closing bodies by executing interlocking control at a time of executing interlocking control when the first and second opening and closing bodies are interlocked to perform the opening and closing operations and an opening and closing operation distance comparison unit for comparing the acquired opening and closing operation distances between the first and second opening and closing bodies.

According to the above configuration, it is possible to synchronize the end timings of the interlocked opening and closing operations of the first and second opening and closing bodies in a wider utilization situation. Accordingly, it is possible to reduce a feeling of dispersion in the interlocked opening and closing operations and ensure a high texture.

Note that each of the above embodiments may be modified as follows. It is possible to implement the above embodiments and the following modifications in combination within a scope where no technical inconsistency arises.

In the respective embodiments mentioned above, at the time of executing the interlocking control, the first and second opening and closing bodies 71 and 72 are configured to reach the target positions substantially simultaneously through the synchronous control of the end timings. However, the synchronization of the end timings is not limited thereto, but may not necessarily be completely simultaneous. There may be a certain degree of deviation. A configuration is sufficient in which the end timings of the interlocked opening and closing operations of the first and second opening and closing bodies 71 and 72 may become closer as compared with a case where the synchronous control is not performed.

Furthermore, for example, it may be configured such that, at the time of the full-closing operation in which the first and second opening and closing bodies 71 and 72 are interlocked, the end timings of the opening and closing operations thereof are synchronized in consideration of the “closing” by the working of the closer. For example, the end timings of the opening and closing operations by the actuation of each actuator 61 and 62 are set as the first end timing, and the end timing of the “closing” by the working of the closer is set as the second end timing. Then, it may be configured such that the synchronous control is executed, at the time of the full-closing operation in which the first and second opening and closing bodies 71 and 72 are interlocked, so as to set the second end timing substantially the same therewith.

In the third embodiment, the check position Pw is set to the preceding opening and closing body Da having a long opening and closing operation distance γ, among the first and second opening and closing bodies 71 and 72, and the succeeding opening and closing body Db having a short opening and closing operation distance γ is caused to stand by. Then, the end timings of the opening and closing operations of the first and second opening and closing bodies 71 and 72 are synchronized by delaying the working start timing of the succeeding opening and closing body Db until the preceding opening and closing body Da reaches the check position Pw.

However, such is not restrictive, and a standby time may be set for the succeeding opening and closing body Db to let it stand by. It may be configured such that a standby time is set to the succeeding opening and closing body Db so as to cause the opening and closing body Db to stand by, and then, the standby of the succeeding opening and closing body Db is canceled as the standby time elapses. A similar configuration may also be applied to the first embodiment. Even the use of such a configuration makes it possible to provide the same effects as provided by the respective embodiments mentioned above.

In the first and second embodiments, the synchronous control of the end timings is executed during the interlocked full-closing operations from the full-open position P1 and the interlocked full-opening operations from the full-closed position P0. However, the configuration is not limited thereto, and may be implemented such that the synchronous control of the end timings is executed only for the interlocked full-closing operations. It may be also configured such that the synchronous control of the end timings is executed only for the interlocked full-opening operations.

In addition, the third and fourth embodiments each exemplify the application of the synchronous control for a case where the first and second opening and closing bodies 71 and 72 perform a full-closing operation or a full-opening operation in an interlocking manner from a state where either one or both of the first and second opening and closing bodies 71 and 72 stops between the full-closed position P0 and the full-open position P1. However, the configuration is not limited thereto, and the synchronous control of the end timings may be applied to the interlocking control other than the full-closing operation and the full-opening operation. That is, the target positions of the first and second opening and closing bodies 71 and 72 in the interlocking control are arbitrary. Also in this case, it may be configured such that the synchronous control of the end timings may be applied only to either one of the case where the first and second opening and closing bodies 71 and 72 are interlocked to perform the closing operations, and the case where the first and second opening and closing bodies are interlocked to perform the opening operation.

In the respective embodiments mentioned above, the front door 11 and the rear door 12 provided in the door opening 3 of the vehicle 1 having a so-called pillar-less structure are set as first and second opening and closing bodies 71 and 72. The control device 70 includes, as the opening and closing control unit, a first opening and closing control unit 73 that controls the working of the first opening and closing body 71 and a second opening and closing control unit 74 that controls the working of the second opening and closing body 72. However, the configuration is not limited thereto, and may be implemented so as to include an opening and closing control unit in which the functions of the first opening and closing control unit 73 and the second opening and closing control unit 74 are integrated.

In the second embodiment, as for the opening and closing operation speed Va of the front door 11 having a relatively short opening and closing operation distance a, control is executed on the working of the front door 11, at the time of the interlocking control, with an opening and closing operation speed V2 slower than the opening and closing operation speed V1 at the time of the individual control. However, the configuration is not limited thereto, and the opening and closing operation speed Vb of the rear door 12 having a relatively long opening and closing operation distance β may be increased at the time of the interlocking control.

In the first and third embodiments, the start timing of the opening and closing operation of one side, among the first and second opening and closing bodies 71 and 72, having a shorter opening and closing operation distance, is delayed. In the second and fourth embodiments, control is executed such that another side, among the first and second opening and closing bodies 71 and 72, having a longer opening and closing operation distance as compared with the one side having a shorter opening and closing operation distance, has a relatively faster opening and closing operation speed. However, the configuration is not limited thereto, and may be implemented so as to synchronize the end timings of the opening and closing operations by combining the delay of the start timing and the change in the relative speed.

In the respective embodiments mentioned above, the actuators 61 and 62 that drive the front door 11 and the rear door 12 to open and close are configured to have substantially equal driving performances, but the embodiments may be applied to a configuration in which the actuators 61 and 62 have different driving performances.

In the respective embodiments mentioned above, the front door 11 and the rear door 12 are supported by the door opening 3 via the link mechanisms 13 and 14. However, the configuration is not limited thereto, and the support structure may be arbitrarily changed as long as the front door 11 and the rear door 12 function as the first and second opening and closing bodies 71 and 72 that perform opening and closing operations in directions opposite to each other, that is, have a configuration as a so-called double-opening door. For example, the embodiments may be applied to the front door 11 and the rear door 12 configured as double-opening sliding doors. Furthermore, the embodiments may be applied to the front door 11 and the rear door 12 configured as so-called gatefold-type sliding doors. Besides, the embodiments may be applied to the front door 11 and the rear door 12 having support structures different from each other.

Furthermore, the first and second opening and closing bodies 71 and 72 may not necessarily be the front door 11 and the rear door 12 of the vehicle 1. For example, the embodiments may be applied to first and second opening and closing bodies 71 and 72 provided in a rear hatch that opens toward the rear of the vehicle 1. An opening other than the door opening 3 provided in the vehicle 1 may be applied to a configuration in which the first and second opening and closing bodies 71 and 72 open and close.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicular opening and closing body control device comprising an opening and closing control unit for causing first and second opening and closing bodies that are provided in an opening of a vehicle and perform opening and closing operations in directions opposite to each other, to perform the opening and closing operations, wherein
the opening and closing control unit synchronizes end timings of the opening and closing operations of the first and second opening and closing bodies having different opening and closing operation distances when the first and second opening and closing bodies are interlocked to perform opening operations and closing operations.

2. The vehicular opening and closing body control device according to claim 1, wherein
the opening and closing control unit delays a start timing of the opening and closing operation of one side, among the first and second opening and closing bodies, having the opening and closing operation distance that is shorter.

3. The vehicular opening and closing body control device according to claim 1, wherein
the opening and closing control unit executes control such that, as compared with one side, among the first and second opening and closing bodies, having the opening and closing operation distance that is shorter, another side having the opening and closing operation distance that is longer has a relatively faster opening and closing operation speed.

4. The vehicular opening and closing body control device according to claim 1, wherein
the first and second opening and closing bodies have the opening and closing operation distances that differ from each other in a full-closing operation of moving from a full-open position to a full-closed position and a full-opening operation of moving from the full-closed position to the full-open position, and
the opening and closing control unit synchronizes the end timings for at least either one of the interlocked full-closing operations and the interlocked full-opening operations.

5. The vehicular opening and closing body control device according to claim 2, wherein
the first and second opening and closing bodies have the opening and closing operation distances that differ from each other in a full-closing operation of moving from a full-open position to a full-closed position and a full-opening operation of moving from the full-closed position to the full-open position, and
the opening and closing control unit synchronizes the end timings for at least either one of the interlocked full-closing operations and the interlocked full-opening operations.

6. The vehicular opening and closing body control device according to claim 3, wherein
the first and second opening and closing bodies have the opening and closing operation distances that differ from each other in a full-closing operation of moving from a full-open position to a full-closed position and a full-opening operation of moving from the full-closed position to the full-open position, and
the opening and closing control unit synchronizes the end timings for at least either one of the interlocked full-closing operations and the interlocked full-opening operations.

7. The vehicular opening and closing body control device according to claim 1, wherein
the opening and closing control unit controls at least either one of the first and second opening and closing bodies at different opening and closing operation speeds between at a time of executing individual control when the first and second opening and closing bodies are caused to perform the opening and closing operations individually, and at a time of executing interlocking control when the first and second opening and closing bodies are caused to perform the opening and closing operations together.

8. The vehicular opening and closing body control device according to claim 1, comprising
an opening and closing operation distance acquisition unit for acquiring the opening and closing operation distances of the first and second opening and closing bodies by executing interlocking control at a time of executing interlocking control when the first and second opening and closing bodies are interlocked to perform the opening and closing operations, and
an opening and closing operation distance comparison unit for comparing the acquired opening and closing operation distances between the first and second opening and closing bodies.
